(19) United States
(12) Patent Application Publication
(10) Pub. No.: US 2025/0391422 A1
(43) Pub. Date: Dec. 25, 2025

(54) Systems And Methods For Identifying Characteristics Of Audio Source Origins

(71) Applicant: VoxEQ, Inc., Jacksonville, FL (US)

(72) Inventors: John W. Caven, III, Jacksonville, FL (US); Christopher K. Eveland, Nashville, TN (US)

(21) Appl. No.: 18/750,491

(22) Filed: Jun. 21, 2024

(51) Int. Cl. G10L 25/63; G10L 17/26; G10L 25/60

(52) U.S. Cl. CPC G10L 25/63; G10L 17/26; G10L 25/60

(57) ABSTRACT

The present disclosure provides for an audio analytics system. The audio analytics system may comprise one or more audio sources. The audio analytics system may comprise one or more training sources. The audio analytics system may use the training sources to generate an amount of training data that may be used to train at least one artificial intelligence infrastructure of the audio analytics system. The audio analytics system may comprise at least one audio capture device. The audio analytics system may be configured to receive at least one audio source via the audio capture device to enable the artificial intelligence infrastructure to execute at least one operation on the audio source to identify one or more potential origin characteristics associated with an origin of the audio source.

### BACKGROUND

Speech is much more than its semantic components. Through speech, humans convey nonverbal characteristics, called emotional prosody, that allow individuals to convey and express their emotions. The human brain has different channels for its vocal and verbal components, the vocal channel working to convey emotions felt by a speaker through intensity, rhythm, and pitch. Decoding emotion is a part of everyday conversation, with certain emotions being more easily distinguished by listeners than others. For example, anger and sadness can be detected more readily than fear and happiness.

The ability to convey nonverbal meanings through speech can be used for purposes beyond understanding emotion. Speech pathologists study the human voice to diagnose an array of mental and physical conditions. One example of this is dysarthria, a speech disorder caused by muscle weakness. If an individual is having trouble speaking, such as by using slurred or slowed speech, a medical professional may use these symptoms as a basis for diagnosis.

Artificial intelligence (“AI”), the creation of machines that replicate human intelligence, has started to explore speech analytics. Voice analytics technologies boast high accuracy in their ability to understand the semantic aspects of a person's voice, with the ability to identify individual speakers increasing in more recent times. Current AI voice recognition technologies come in two forms: (1) verification and authentication; (2) identification.

Verification and authentication involve the comparison of prerecorded or preexisting voice data to a particular speaker, either confirming or denying a match therebetween. Alternatively, speaker identification involves an analysis and comparison of vocal audio to known speakers, working to try and match an unknown speaker to existing data. These current voice analytic technologies offer little use in terms of emotion prosody and speech pathology.

One difficulty in expanding audio analytics towards the nonverbal aspects of speech is considerable, especially in light of the fact that most humans cannot accurately understand such information themselves. Current AI Models lack the algorithms and data to understand, analyze, and predict non-semantic information within speech. This limits the application of such technologies in fields that rely on audio information that goes beyond the semantic content of the audio.

### SUMMARY OF THE DISCLOSURE

What is needed are systems and methods to supplement, mimic, or improve upon the innate human ability to analyze audio sources to detect deviations in the physical, mental, or emotional state of an origin of an audio source via audio analysis. Systems and methods configured to identify one or more potential origin characteristics of an origin of an audio source that may be indicative of such physical, mental, or emotional states are also desired.

In some aspects, the present disclosure provides for an audio analytics system configured to capture and analyze one or more audio or visual sources. In some implementations, the system may comprise at least one artificial intelligence infrastructure that may be trained to receive at least one audio source and execute at least one operation on the audio source to identify one or more potential origin characteristics, such as, for example and not limitation, the health or well-being of an origin of the audio source, wherein the origin of the audio source may comprise a human or animal, as non-limiting examples.

In some aspects, the audio analytics system of the present disclosure may be trained to identify one or more potential origin characteristics of an origin of an audio source that may indicate, for example and not limitation, whether the origin is under the influence of substances, is incapacitated in some way, or is experiencing one or more health problems. In some non-limiting exemplary embodiments, the audio analytics system may be implemented in a variety of settings, including conversations; telephonic conversations, such as those involving government agencies or financial services institutions; security assessments; equipment and vehicle control systems; online communities; the metaverse; forensics; intelligence; or health care environments, as non-limiting examples.

In some implementations, the audio analytics system of the present disclosure may comprise at least one audio capture device. In some non-limiting exemplary embodiments, the audio capture device may be configured to receive one or more audio sources and facilitate the execution of at least one operation on the audio source(s), either within the audio capture device or one or more other components of the audio analytics system, such as within one or more servers communicatively coupled to the audio capture device, as a non-limiting example. In some aspects, execution of the at least one operation may enable the audio analytics system to identify one or more potential origin characteristics associated with the origin of the audio source. By way of example and not limitation, a potential origin characteristic of an audio source may comprise one or more of: a physical, mental, or emotional condition of the audio source.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary audio analytics system, according to some embodiments of the present disclosure.

FIG. 2 illustrates an exemplary machine learning process for an audio analytics system, according to some embodiments of the present disclosure.

FIG. 3A illustrates an exemplary audio analytics system comprising an audio source and an audio capture device, according to some embodiments of the present disclosure.

FIG. 3B illustrates an exemplary audio analytics system comprising an audio source and an audio capture device, according to some embodiments of the present disclosure.

FIG. 3C illustrates an exemplary audio analytics system comprising an audio source and an audio capture device, according to some embodiments of the present disclosure.

FIG. 4A illustrates an exemplary audio analytics system comprising an audio source and an audio capture device, according to some embodiments of the present disclosure.

FIG. 4B illustrates an exemplary audio analytics system comprising an audio source and an audio capture device, according to some embodiments of the present disclosure.

FIG. 5 illustrates an exemplary audio analytics system comprising an audio source and an audio capture device, according to some embodiments of the present disclosure.

FIG. 6 illustrates an exemplary origin characteristic result determined by an audio analytics system, according to some embodiments of the present disclosure.

FIG. 7 illustrates an exemplary audio analytics system comprising an audio source, according to some embodiments of the present disclosure.

FIG. 8 illustrates a block diagram of an exemplary computing device that may at least partially comprise an audio analytics system, according to some embodiments of the present disclosure.

The Figures are not necessarily drawn to scale, as their dimensions can be varied considerably without departing from the scope of the present disclosure.

### DETAILED DESCRIPTION

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Audio Characteristic: as used herein refers to at least one aspect of an audio source. In some aspects, an audio characteristic may comprise volume, tone, rhythm, inflection, pitch, base, frequency, or one or more image processing analytics, as non-limiting examples. Origin Characteristic: as used herein refers to at least one physical, mental, or emotional characteristic associated with an origin of at least one audio source. In some aspects, an origin characteristic may comprise an age, age range, height, weight, gender, sex, hormonal development, race, ethnicity, identification, emotional state, mental state, fatigued status, or level of neurological impairment of an origin, as non-limiting examples.
Audio Source: as used herein refers to any auditory sound emitted by at least one origin, wherein an origin may comprise the originator of the auditory sound. In some non-limiting exemplary embodiments, an audio source may comprise an animal vocalization. In some aspects, by way of example and not limitation, an audio source may comprise a previously emitted auditory sound stored within at least one storage medium. In some aspects, by way of further example and not limitation, an audio source may at least partially comprise a live audio stream.
Audio Capture Device: as used herein refers to any device used to capture or receive at least one audio source. By way of example and not limitation, an audio capturing device may comprise a microphone, camera, or a recording device.
Operation: as used herein refers to any action that may be executed on at least one audio source by at least one computing device. By way of example and not limitation, an operation may comprise any function, process, procedure, algorithm, artificial intelligence application, or machine learning process that may be used to at least partially analyze at least one audio source. By way of further example and not limitation, an operation may be executed during the performance of a neural network or support vector machine.
Parameter: as used herein refers to any element that may influence an operation executed by at least one computing device. In some aspects, a parameter may comprise one or more weights, one or more biases, one or more values, and/or one or more inputs.
Embedding: as used herein, refers to a condensed data set comprising one or more origin characteristics at least partially derived from at least one audio source. In some embodiments, an embedding may comprise a resultant data set produced after an audio source is processed by at least one artificial intelligence infrastructure. In some implementations, an embedding may comprise audio source data that excludes information that is irrelevant to any origin characteristics of an origin of an audio source, such as, for example and not limitation, the content of one or more spoken sounds or background noise, as non-limiting examples.

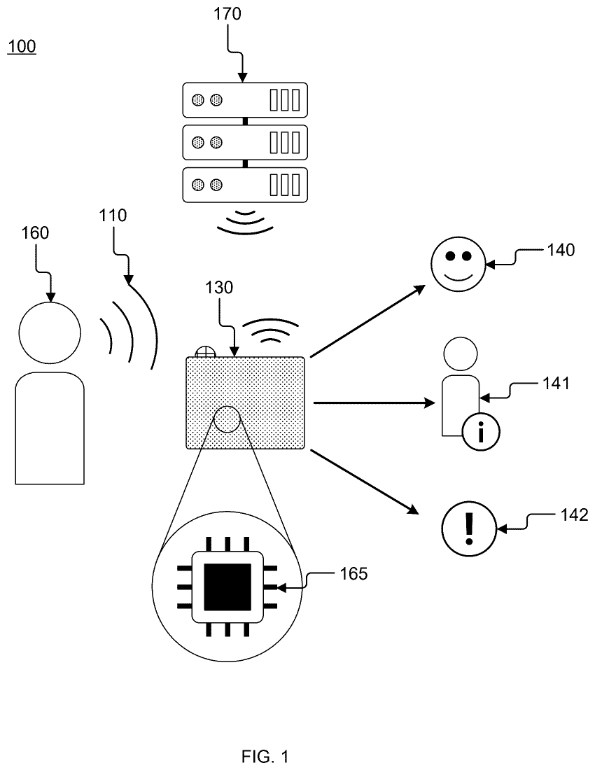

Referring now to FIG. 1, an exemplary audio analytics system 100, according to some embodiments of the present disclosure, is illustrated. In some aspects, the audio analytics system 100 may comprise at least one audio source 110. In some implementations, the audio analytics system 100 may comprise at least one audio capture device 130. In some implementations, the audio analytics system 100 may be configured to identify one or more potential origin characteristics 140, 141, 142 associated with an origin 160 of the audio source 110, wherein the potential origin characteristics 140, 141, 142 may be presented to at least one user of the audio analytics system 100. In some embodiments, the audio capture device 130 may at least partially comprise at least one computing device. In some implementations, the audio capture device 130 may be communicatively coupled to at least one computing device, such as via a wireless connection or a hardwired connection, as non-limiting examples. In some non-limiting exemplary embodiments, the audio capture device 130 may at least partially comprise or may be communicatively coupled to at least one computing device that comprises one or more of: a central processing unit (“CPU”), a graphics processing unit (“GPU”), an edge computing device, a system on a chip, a tensor core, a headset, an on-board vehicle computer, a smartphone, a smart watch, a laptop computer, a tablet computer, a desktop computer, a gaming console, a virtual reality device, an augmented reality device, a smart speaker, or a hearing aid, as non-limiting examples. In some aspects, the audio capture device 130 may comprise at least one of: a peripheral device and a sensing device.

In some implementations, the audio capture device 130 may be configured to receive at least one audio source 110. By way of example and not limitation, the audio capture device 130 may receive the audio source 110 via at least one input element, such as a microphone or network or broadcast connection, as non-limiting examples. In some aspects, the audio analytics system 100 may be configured to execute at least one operation on the audio source 110, wherein execution of the at least one operation may allow the audio analytics system 100 to identify one or more potential origin characteristics 140, 141, 142 associated with an origin 160 of the audio source 110. By way of example and not limitation, potential origin characteristics 140, 141, 142 may comprise a physical, mental, or emotional status associated with the origin 160 of the audio source 110. By way of further example and not limitation, potential origin characteristics 140, 141, 142 may comprise one or more of: an age, an age range, a height, a height range, a length, a length range, a weight, a weight range, a gender, a sex, a hormonal development, a race, an ethnicity, a species, a breed, or an identification of the origin 160 of the audio source 110.

In some aspects, the audio analytics system 100 may comprise at least one storage medium 165. In some non-limiting exemplary embodiments, the storage medium 165 may at least partially comprise an amount of volatile memory for streaming data. In some implementations, the storage medium 165 may comprise one or more parameters that may be used or referenced during the execution of the operations on the audio source 110. In some non-limiting exemplary embodiments, the parameters may comprise one or more weights, biases, or similar values, modifiers, or inputs. In some aspects, at least a portion of the parameters may be adjustable to improve the accuracy of the potential origin characteristics 140, 141, 142 identified for the origin 160 of the audio source 110.

In some implementations, the audio analytics system 100 may comprise at least one artificial intelligence infrastructure. In some non-limiting exemplary embodiments, the artificial intelligence infrastructure may be communicatively coupled to the audio capture device 130. In some implementations, the audio capture device 130 may comprise the artificial intelligence infrastructure. In some aspects, the artificial intelligence infrastructure may be configured to at least partially execute the at least one operation on the audio source 110. In some embodiments, the artificial intelligence infrastructure may be at least partially configured within one or more external or remote computing devices or servers 170 that may be communicatively coupled to the audio capture device 130 via at least one network connection, such as, for example and not limitation, via a connection to the global, public Internet or via a connection to a local area network (“LAN”). In some non-limiting exemplary implementations, the artificial intelligence infrastructure may be stored within one or more external or remote computing devices or servers 170 that may be communicatively coupled to the audio capture device 130 directly without using any network connection, such as, for example and not limitation, in a disconnected edge computing environment. By way of example and not limitation, the artificial intelligence infrastructure may comprise at least one of: a neural network, a deep neural network, a convolutional neural network, or a support vector machine. By way of further example and not limitation, the artificial intelligence infrastructure may be at least partially configured within one or more of: a central processing unit (“CPU”), a graphics processing unit (“GPU”), an edge computing device, a system on a chip, or a tensor core, as non-limiting examples.

In some aspects, the audio analytics system 100 may comprise a plurality of artificial intelligence infrastructures. In some non-limiting exemplary embodiments, the audio analytics system 100 may comprise a first artificial intelligence infrastructure and a second artificial intelligence infrastructure. In some implementations, the first artificial intelligence infrastructure may be configured to at least partially execute a first at least one operation on the audio source 110 using a first set of parameters and the second artificial intelligence infrastructure may be configured to at least partially execute a second at least one operation on the audio source 110 using a second set of parameters.

In some embodiments, the first artificial intelligence infrastructure of the audio analytics system 100 may be configured to identify one or more audio characteristics of the audio source 110. In some implementations, the audio characteristics may be identified via a first at least one operation that may be executed on the audio source 110 and a second at least one operation may be executed on the identified audio characteristics of the audio source 110 to identify one or more potential origin characteristics 140, 141, 142 associated with an origin 160 of the audio source 110. In some aspects, at least one operation may be executed directly on the audio source 110 to identify one or more potential origin characteristics 140, 141, 142 without first identifying any audio characteristics. In some implementations, one or more audio characteristics may be identified or determined for the audio source 110 by one or more processes or analytical methods that do not comprise executing at least one operation on the audio source 110. By way of example and not limitation, audio characteristics of the audio source 110 may comprise one or more of: volume, tone, rhythm, inflection, pitch, base, vibrational frequency, image processing analytics, or similar aspects of the audio source 110. By way of further example and not limitation, potential origin characteristics 140, 141, 142 may comprise one or more physical, mental, or emotional features or states of an origin 160 of the audio source 110. In some non-limiting exemplary embodiments, the first at least one operation and the second at least one operation may be executed by the same artificial intelligence infrastructure.

In some embodiments, an audio source 110 may comprise one or more audio characteristics that may be captured by at least one audio capture device 130, wherein the audio characteristics may be identified or determined via the audio analytics system 100. In some aspects, the audio source 110 may comprise audio characteristics of one or more sound waves produced by the vibrations of one or more vocal cords, the sound of air passing in or out of a human or animal mouth or nose during breathing processes, wheezing or coughing sounds associated with the functioning of lungs, a resonance occurring in one or more nasal cavities, or any similar sounds, as non-limiting examples. In some aspects, the audio source 110 may comprise one or more audio characteristics of one or more sound waves that may be directly emitted by a human or animal or one or more reproduced human or animal sounds. By way of example and not limitation, a reproduced sound may comprise one or more live or previously recorded sounds that may be output by at least one audio emitting device instead of being directly emitted from a human or animal. By way of further example and not limitation, in some embodiments, the audio emitting device that produces one or more reproduced sounds may comprise at least one speaker.

As a non-limiting illustrative example, the audio from a conversation between two or more people may be captured, recorded, and processed or analyzed by the audio analytics system 100. In some aspects, the tone, cadence, inflection, and other audio characteristics of the vocal sounds produced by the individuals in the conversation may be captured via at least one audio capture device 130 in the form of, for example and not limitation, a microphone associated with a portable computing device, such as a smartphone or tablet computer that may be proximate to the individuals such that the microphone may be able to detect the conversation.

In some aspects, the audio source 110 may be captured by the audio capture device 130 and used by the audio analytics system 100 to determine at least one potential origin characteristic 140, 141, 142 related to an origin 160 of the audio source 110. By way of example and not limitation, a potential origin characteristic 140, 141, 142 of an origin 160 may comprise one or more of: a physical, mental, or emotional condition of the origin 160 of the audio source 110. By way of further example and not limitation, a potential origin characteristic 140, 141, 142 may comprise at least one of: an age, an age range, a height, a height range, a length, a length range, a weight, a weight range, a gender, a sex, a hormonal development, a race, an ethnicity, a species, a breed, or an identification of the origin 160 of the audio source 110.

As a non-limiting illustrative example, the audio source 110 may comprise a person's voice, which may be captured and processed or analyzed to identify or determine one or more potential origin characteristics 140, 142 regarding the emotional or mental state of the person comprising the origin 160 of the audio source 110. In some implementations, this identification may at least partially comprise the audio analytics system 100 performing or executing at least one operation on the audio source 110. In some aspects, the audio analytics system 100 may comprise at least one storage medium 165, wherein the storage medium 165 may comprise one or more parameters that may be utilized or referenced to at least partially execute the at least one operation on the captured audio source 110. By way of example and not limitation, the parameter(s) within the storage medium 165 may comprise one or more weights, biases, or similar values, modifiers, or inputs that may at least partially influence any resulting output(s) from the at least one operation. In some non-limiting exemplary embodiments, at least a portion of the one or more parameters may be adjustable to modify the accuracy of the potential origin characteristics 140, 141, 142 identified via the execution of the at least one operation on the captured audio source 110.

In some implementations, an audio source 110 may be captured by at least one audio capture device 130. The captured audio source 110 may then be used by the audio analytics system 100 to identify at least one potential origin characteristic 141 associated with the audio source 110. As a non-limiting illustrative example, the audio source 110 may comprise a person's voice, which may be captured and processed or analyzed to identify or determine one or more potential origin characteristics 141 related to the origin 160 of the audio source 110 such as, by way of example and not limitation, one or more physical attributes of the origin 160, i.e., the person speaking. In some embodiments, the audio capture device 130 may comprise at least one storage medium 165, wherein the storage medium 165 may comprise one or more adjustable parameters that may be utilized or referenced during execution of the at least one operation on the captured audio source 110.

In some non-limiting exemplary embodiments, the audio analytics system 100 may comprise one or more parameters that may allow the audio analytics system 100 to identify one or more potential origin characteristics 140, 141, 142 that may be affected by differences in sound waves produced by the vocal cords of humans or animals of different genders, sexes, hormonal developments, ages, heights, lengths, weights, species, breeds, races, or ethnicities, as non-limiting examples, as the length, stiffness, vibrational frequency, and/or resonance of vocal cords may be affected by any or all of these factors, thereby causing the vocal cords of different humans or animals to produce sound waves that differ in at least one aspect. By way of example and not limitation, a human voice may be captured and processed or analyzed to identify potential origin characteristics 140, 141, 142 that indicate that a person is likely a 6′5 tall, 55-year-old male that weighs approximately 200 pounds.

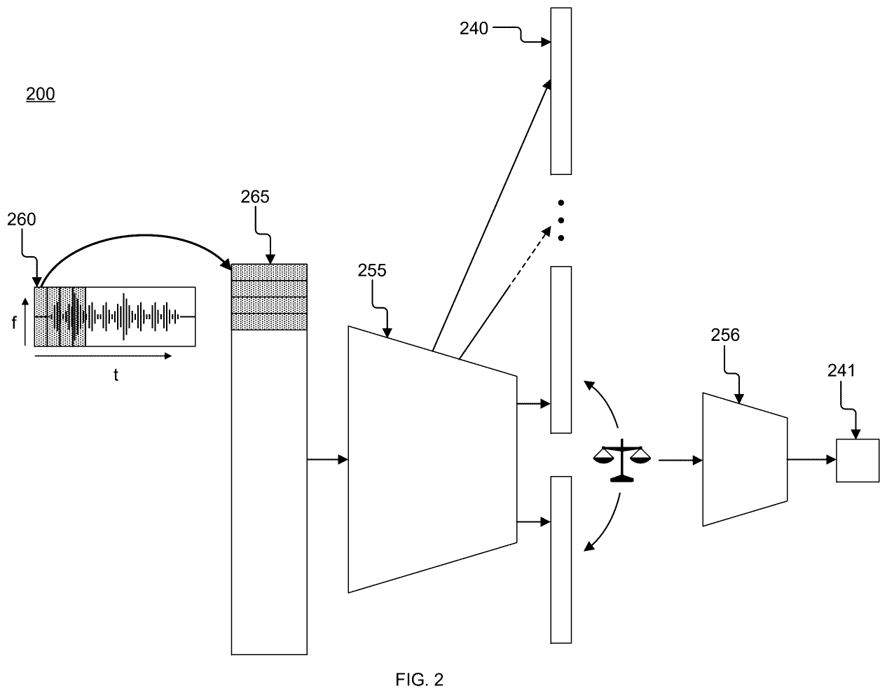

Referring now to FIG. 2, an exemplary machine learning process 200 for an audio analytics system, according to some embodiments of the present disclosure, is illustrated. In some aspects, the machine learning process 200 may comprise at least one artificial intelligence infrastructure 255, 256 that may be at least partially trained using at least one datum of training data 265, wherein the training data 265 may be derived from a plurality of training sources 260, wherein each of the training sources 260 may comprise at least one type or form of sound or audio that comprises one or more sound waves. In some non-limiting exemplary embodiments, each artificial intelligence infrastructure 255, 256 may comprise at least three layers, wherein each layer may comprise one or more nodes. By way of example and not limitation, each artificial intelligence infrastructure 255, 256 may comprise at least one input layer, at least one output layer, and one or more hidden intermediate layers. In some aspects, the nodes of one layer may be connected to the nodes of an adjacent layer via one or more channels. In some implementations, each channel may be assigned a numerical value, or weight. In some embodiments, each node within the one or more intermediate layers may be assigned a numerical value, or bias. Collectively, the weights of the channels and the biases of the nodes may comprise one or more parameters that may be at least temporarily stored within at least one storage medium.

In some aspects, the training data 265 may be initially received by the input layer of a first artificial intelligence infrastructure 255. In some implementations, the first artificial intelligence infrastructure 255 may then execute one or more operations on the training data 265 as the training data 265 is propagated through one or more intermediate layers, wherein the one or more operations may reference at least a portion of the stored parameters during execution thereof. In some embodiments, once the training data 265 reaches the output layer of the first artificial intelligence infrastructure 255, a first set of one or more potential origin characteristics 240 associated with the training data 265 may be identified, wherein the first set of potential origin characteristics 240 may comprise an embedding. In some implementations, training data 265 may be received by the first artificial intelligence infrastructure 255 from a plurality of training sources 260 contemporaneously, and the first artificial intelligence infrastructure 255 may produce an embedding for each training source 260.

In some implementations, each embedding may be further propagated through a second artificial intelligence infrastructure 256 to identify a second set of one or more potential origin characteristics 241 associated with the training data 265. In some embodiments, the embedding produced by the first artificial intelligence infrastructure 255 may at least partially facilitate the identification of the second set of potential origin characteristics 241 by the second artificial intelligence infrastructure 256, wherein the second set of potential origin characteristics 241 may be more accurately identified by executing one or more operations on the relatively small dimensionality of each embedding compared to the original training sources 260. In some non-limiting exemplary implementations, the first artificial intelligence infrastructure 255 may comprise a convolutional neural network and the second artificial intelligence infrastructure 256 may comprise a multilayer perceptron.

As a non-limiting illustrative example, a plurality of training sources 260 may be received by an audio analytics system, wherein the plurality of training sources 260 may comprise various animal sounds. The training data 265 comprising the animal sounds may be propagated through a first artificial intelligence infrastructure 255, which may execute a first at least one operation on the training data 265 to identify which animal sounds comprise cat sounds, wherein the identification of sounds as being emitted from a cat may comprise an embedding for each training source 260 emitted from a cat, wherein the embedding comprises a first set of potential origin characteristics 240. Each embedding may then be propagated through a second artificial intelligence infrastructure 256, wherein a second at least one operation may be executed on each embedding to identify one or more attributes of the cat emitting the sounds, such as the sex of the cat or whether the cat is hungry, as non-limiting examples, wherein such attributes may comprise a second set of potential origin characteristics 241. In some non-limiting exemplary embodiments, training data 265 derived from training sources 260 that are similar to the embeddings produced by the first artificial intelligence infrastructure 255 may be propagated through the second artificial intelligence infrastructure 256 to identify one or more potential origin characteristics 241 for such training sources 260. As a non-limiting illustrative example, if the embeddings produced by the first artificial intelligence infrastructure 255 comprise cat sounds, and the second artificial intelligence infrastructure 256 has been trained to identify potential origin characteristics 241 for the cats emitting the sounds, then one or more training sources 260 comprising fox sounds may be processed by the second artificial intelligence infrastructure 256 to identify one or more potential origin characteristics 241 that comprise attributes of the foxes emitting the sounds, wherein the second artificial intelligence infrastructure 256 may transfer the learned identification of potential origin characteristics 241 for cats to foxes

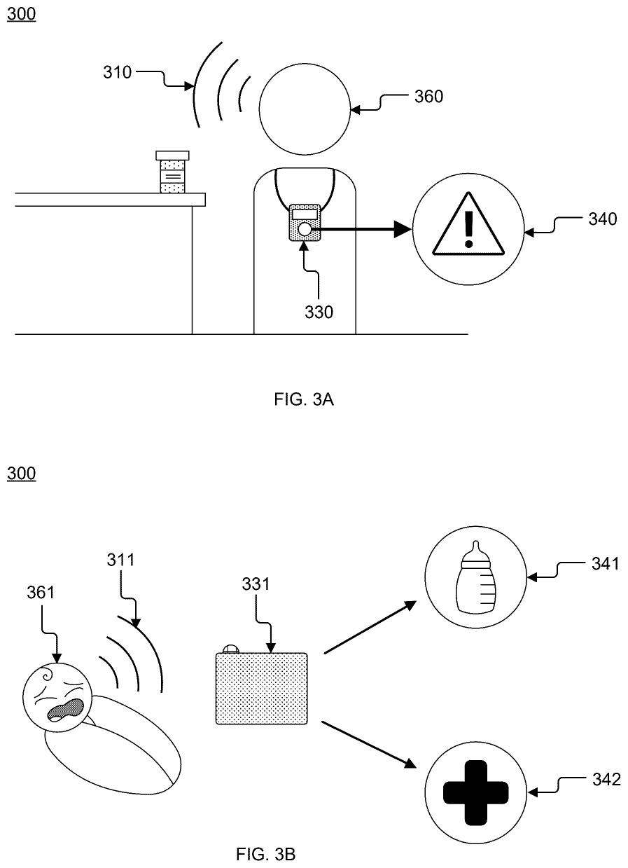

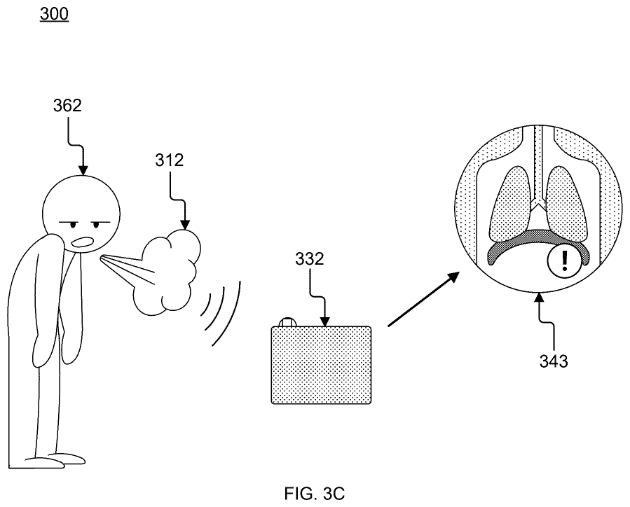

Referring now to FIGS. 3A-C, an exemplary audio analytics system 300 comprising an audio source 310 and an audio capture device 330, according to some embodiments of the present disclosure, is illustrated. In some aspects, the audio analytics system 300 may comprise at least one audio source 310, 311, 312. In some implementations, the audio analytics system 300 may comprise at least one audio capture device 330, 331, 332. In some aspects, the audio analytics system 300 may be configured to identify and present one or more potential origin characteristics 340, 341, 342, 343 related to an origin 360, 361, 362 of the audio source 310, 311, 312.

In some embodiments, the audio analytics system 300 may comprise at least one audio source 310. In some aspects, the audio analytics system 300 may comprise at least one audio capture device 330. In some embodiments, the audio capture device 330 may be configured to capture an audio source 310 to facilitate home medicine monitoring.

As a non-limiting illustrative example, the audio capture device 330 may comprise a wearable technology device, such as a smartwatch, smart glasses, or a device attached to a necklace or wristband, as non-limiting examples, or the audio capture device 330 may comprise a standalone device that may be fixed or placed in a centralized location. In some aspects, by way of example and not limitation, a user of the audio capture device 330 may comprise an origin 360 of an audio source 310, and the user may experience a medical emergency related to negative interactions between two or more ingested medications, and the user's voice may be captured by the audio capture device 330 such that the audio capture device 330 may process or analyze the user's voice by executing one or more operations on the user's vocal data to identify one or more potential origin characteristics 340 that may be related to subtle changes associated with how the interaction of the medications may affect the nerves and muscles associated with the user's vocal cords, thereby recognizing the medical emergency.

To further illustrate the previous example, the user may experience difficulty breathing, which may be a symptom of a heart attack, and by capturing and identifying audio characteristics associated with the user's disrupted breathing pattern, the audio analytics system 300 may be configured to execute one or more operations on the audio source 310 comprising the breathing pattern to identify one or more potential origin characteristics 340 that may comprise a diagnosis of the heart attack. In some non-limiting exemplary embodiments, upon diagnosing the heart attack or any other medical emergency, the audio capture device 330 may be configured to output one or more forms of communication, such as an automated phone call, text message, or similar notification, to alert one or more relevant authorities or one or more emergency contacts of the user in an at least partiality autonomous fashion so that the user may be able to receive potentially lifesaving medical attention in a timely fashion.

In some implementations, a medical emergency may be detected by the audio analytics system 300 when a user makes an audible declaration of such emergency. In some embodiments, the audio capture device 330 may be configured to continuously monitor a user's voice to identify one or more potential origin characteristics 340 that may be associated with significant or subtle changes in the audio produced by the user that may be indicative of a medical emergency. By way of example and not limitation, a stroke may affect a person's speech pattern, and the audio capture device 330 may allow the audio analytics system 300 to detect the disruption in the person's speech, thereby facilitating the ability of the audio analytics system 300 to identify one or more potential origin characteristics 340 that may comprise a diagnosis of the medical emergency being experienced by the user and, in some aspects, contact one or more first responders or emergency contacts in an at least partially autonomous fashion.

In some aspects, at least one audio capture device 331 may be configured to capture and process an audio source 311 so that the audio analytics system 300 may be able to identify one or more potential origin characteristics 341, 342 of the origin 361 of the audio source 311. As a non-limiting example, parents may place the audio capture device 331 in the vicinity of a child so that the audio capture device 331 may be able to identify one or more potential origin characteristics 341, 342 for the child who may be unable to communicate through speech.

To further illustrate the previous example, the audio capture device 331 may be located so as to capture an audio source 311 from an origin 361 that comprises a baby, and by processing or analyzing the captured audio from the baby, the audio analytics system 300 may be able to execute one or more operations on the audio source 311 to identify one or more potential origin characteristics 341, 342 that may indicate why the baby is making certain noises, such as, by way of example and not limitation, by identifying one or more audio characteristics that comprise subtle differences in crying sounds, and then executing one or more operations on the crying sounds to identify one or more potential origin characteristics 341, 342 that may indicate whether the baby is crying for food or crying in pain, as non-limiting examples.

In some aspects, one or more various types of audible non-verbal human communication may be captured by the audio capture device 331 and processed or analyzed by the audio analytics system 300. By way of example and not limitation, a person who is unable to form words may still be able to communicate, such as by using various sounds that may be indicative of different emotions or feelings, and the audio analytics system 300 may be configured to capture and process or analyze those sounds by executing one or more operations on the sounds to identify one or more potential origin characteristics 341, 342 that may indicate the meaning of the sounds. In some non-limiting exemplary embodiments, this may assist caretakers and others who may have trouble understanding a non-verbal person being cared for, so that better care may be provided.

In some implementations, at least one audio capture device 332 may be configured to capture at least one audio source 312 and thereby enable the audio analytics system 300 to identify one or more potential origin characteristics 343 pertaining to an origin 362 of the captured audio source 312. By way of example and not limitation, a user's voice may comprise an audio source 312 that may be received by the audio capture device 332 and processed or analyzed by the audio analytics system 300, wherein the audio analytics system 300 may execute one or more operations on the audio source 312 to identify one or more audio characteristics to establish a baseline for what the user's voice typically sounds like, wherein the user may comprise the origin 362 of the audio source 312. In some embodiments, this may allow the audio analytics system 300 to execute one or more additional operations on the user's voice subsequently received at a later time to identify one or more audio characteristics that may comprise changes in the user's normal breathing sounds that may comprise, for example and not limitation, subtle or substantial changes in the nasality, breathiness, or similar aspects associated with the user's voice and breathing pattern.

To further illustrate the previous example, muscular dystrophy is a medical condition that may affect the diaphragm of a person and may therefore influence the person's vocal projection, voice tone, and breathing patterns. In some aspects, the audio capture device 332 may be able to identify one or more potential origin characteristics 343 that may comprise a diagnosis of muscular dystrophy at an early stage by recognizing even subtle changes in one or more identified audio characteristics associated with an audio source 312 emitted from an origin 362.

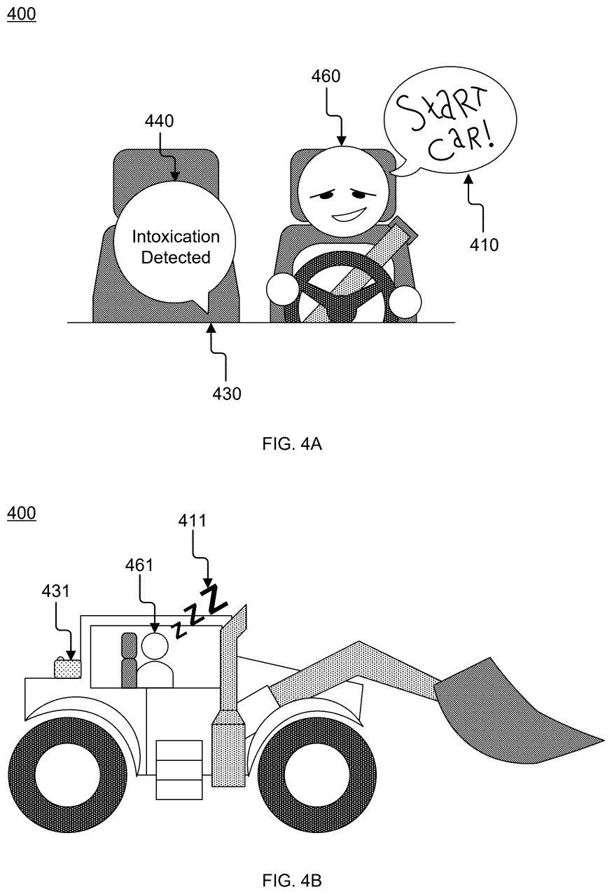

Referring now to FIGS. 4A-B, an exemplary audio analytics system 400 comprising an audio source 410, 411 and an audio capture device 430, 431, according to some embodiments of the present disclosure, is illustrated. In some aspects, the audio analytics system 400 may comprise at least one audio source 410, 411. In some implementations, the audio analytics system 400 may comprise at least one audio capture device 430, 431. In some aspects, the audio analytics system 400 may be configured to identify and present one or more potential origin characteristics 440, related to an origin 460, 461 of the audio source 410, 411.

In some non-limiting exemplary embodiments, an audio capture device 430 may be configured to receive an audio source 410 such that the audio analytics system 400 may be able to execute one or more operations on the audio source 410 to identify one or more potential origin characteristics 440 associated with an origin 460 of the audio source 410 that may indicate that the origin 460 of the audio source 410 may be incapable of completing an action or performing a task. As a non-limiting illustrative example, the audio source 410 may comprise the voice of an intoxicated person, and the audio analytics system 400 may be configured to execute at least one operation on the person's voice that allows the audio analytics system 400 to identify one or more potential origin characteristics 440 that may comprise an indication that the person's vocal cords are being influenced by a depressed central nervous system or other signs of an intoxicated state, wherein the audio analytics system 400 may use the identified potential origin characteristics 440 to determine that the person is intoxicated. In some aspects, by way of example and not limitation, the audio capture device 430 may be installed in a car or other vehicle in a location where the voice of a potential driver of the vehicle may be captured so that the audio analytics system 400 may be able to determine whether the person attempting to operate the vehicle may be intoxicated.

By way of further example and not limitation, in some aspects, the audio analytics system 400 may be integrated into a voice activated starter system of car or other vehicle, wherein the vehicle may be prevented from starting when the audio analytics system 400 determines that the potential driver may be intoxicated; or, the audio analytics system 400 may be configured to alert one or more relevant authorities or provide a warning to the potential driver to deter the individual from operating the vehicle while intoxicated. In some non-limiting exemplary embodiments, the vehicle may only be prevented from starting when the audio analytics system 400 calculates an estimated accuracy of a determined intoxicated state that is above a predetermined minimum threshold value. As a non-limiting illustrative example, the audio analytics system 400 may only prevent a vehicle from starting if the audio analytics system 400 determines that there is at least a 90 percent chance that the potential driver is intoxicated.

In some aspects, at least one audio capture device 431 may be configured to capture an audio source 411 such that the audio analytics system 400 may be able to execute one or more operations on the audio source 411 to identify one or more potential origin characteristics of the origin 461 of the audio source 411 that may indicate that the audio source 411 is incapacitated in some way or is otherwise distracted. As a non-limiting illustrative example, the audio capture device 431 may be located within a vehicle or heavy machinery unit, such as a forklift, in a location that may enable the audio capture device 431 to capture an audio source 411 from an origin 461 that comprises the operator of the vehicle or machinery. In some implementations, by executing at least one operation on data associated with one or more previously captured sounds captured from previous uses of the vehicle or machinery involving the same or different users in a capacitated or lucid state, the audio analytics system 400 may be able to identify one or more expected origin characteristics that may be indicative of such capacitated state, and the audio analytics system 400 may be able to use the expected origin characteristics as a basis for comparison for one or more subsequently identified potential origin characteristics that may be indicative of some form of incapacity, such as when one or more operations may be executed by the audio analytics system 400 on an audio source 411 that comprises one or more vocal sounds produced by fatigued muscles in an operator's vocal cords, thereby causing the audio analytics system 400 to generate one or more origin characteristic results that may comprise a determination that the operator may be asleep, tired, or otherwise incapacitated in some form that would make use of the vehicle or machinery dangerous or unsafe.

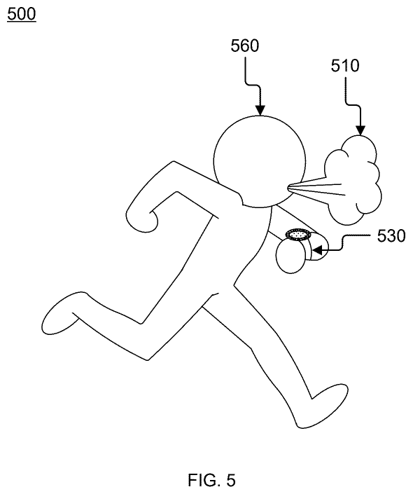

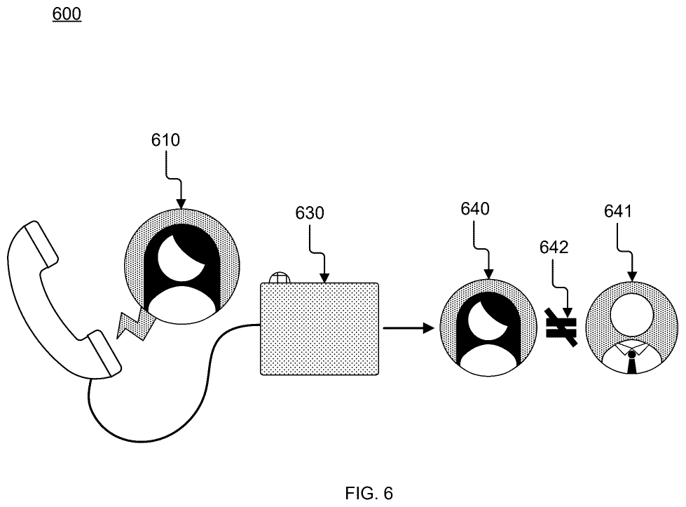

Referring now to FIG. 5, an exemplary audio analytics system 500 comprising an audio source 510 and an audio capture device 530, according to some embodiments of the present disclosure, is illustrated. In some aspects, the audio analytics system 500 may comprise at least one audio source 510. In some implementations, the audio analytics system 500 may comprise at least one audio capture device 530 configured to capture and process or analyze the audio source 510.

In some non-limiting exemplary embodiments, an audio capture device 530 may comprise one or more wearable technology devices, such as a smartwatch or smart glasses, as non-limiting examples, that may be worn on a portion of a user's body, such as, by way of example and not limitation, the user's wrist or head, while the user may be running or engaging in other physical activities. In such aspects, the user may comprise the origin 560 of the audio source 510, which may comprise the user's breathing pattern, breathing intensity, lung sounds, nasal airflow, or similar breath-related noises or sounds, as non-limiting examples. In some implementations, the user's breathing may be captured and processed or analyzed by the audio analytics system 500 to identify one or more potential origin characteristics that may be related to the user's health, such as the user's lung health or breathing capacity, as non-limiting examples.

To further illustrate the previous example, by frequently wearing the audio capture device 530, information regarding the user's breathing or other health-related potential origin characteristics of the user may be regularly received, updated, and managed and used by the audio analytics system 500 to determine whether the user may be experiencing breathing issues or other potential health problems. Additionally, the audio capture device 530 may be used to facilitate an analysis of the user's breathing or other health indicators over time and identify changes in the user's breathing capabilities or other physical health changes.

Referring now to FIG. 6, an exemplary origin characteristic result 642 determined by an audio analytics system 600, according to some embodiments of the present disclosure, is illustrated. In some aspects, the audio analytics system 600 may comprise at least one audio source 610. In some implementations, the audio analytics system 600 may comprise at least one audio capture device 630. In some embodiments, the audio analytics system 600 may be configured to determine and present one or more potential origin characteristics 640 or expected origin characteristics 641 associated with an origin of the audio source 610.

By way of example and not limitation, an audio source 610 may comprise a person's voice on a phone call, wherein the audio capture device 630 may be integrated with or communicatively coupled to the phone, either wirelessly or via a direct wired connection, to capture the person's voice. In some non-limiting exemplary embodiments, the audio capture device 630 may comprise the phone itself, which may comprise a smartphone, as a non-limiting example. In some aspects, the audio capture device 630 may comprise at least one storage medium, wherein the storage medium may comprise one or more parameters that may be utilized to at least partially execute at least one operation on the captured audio source 610. By way of example and not limitation, the parameter(s) within the storage medium may comprise one or more weights, biases, or similar values, modifiers, or inputs. In some non-limiting exemplary embodiments, at least a portion of the parameter(s) may be adjustable to modify the accuracy of one or more potential origin characteristics 640 that may be identified via the execution of the at least one operation on the audio source 610.

In some implementations, the audio capture device 630 may be communicatively coupled to at least one artificial intelligence infrastructure. In some non-limiting exemplary embodiments, the audio capture device 630 may comprise at least one artificial intelligence infrastructure. In some aspects, the artificial intelligence infrastructure may be configured to at least partially execute the at least one operation on the captured audio source 610. By way of example and not limitation, in some aspects, the artificial intelligence infrastructure may comprise at least one of: a neural network, a deep neural network, a convolutional neural network, and a support vector machine.

In some aspects, the audio analytics system 600 may be configured to identify one or more audio characteristics of the captured audio source 610. In some implementations, the audio characteristic(s) may be identified via execution of a first at least one operation on the received audio source 610 and a second at least one operation may be executed on the identified audio characteristic(s) to identify the potential origin characteristic(s) 640 associated with an origin of the audio source 610. In some embodiments, the audio analytics system 600 may be configured to execute one or more operations directly on the audio source 610 to identify one or more potential origin characteristics 640 of the origin.

As a non-limiting illustrative example, the audio analytics system 600 may be implemented as a security measure to help prevent individuals from being victimized by fraud. For instance, a bad actor may call an elderly person claiming to be the person's grandson and ask for money. As a security precaution, an audio capture device 630 in the form of the person's phone or integrated with the person's phone system may receive the caller's voice and process the voice data to attempt to verify the identity of the caller and determine whether the caller is actually the grandson of the person being called. In some aspects, this determination may at least partially comprise a comparative analysis between one or more identified potential origin characteristics 640 of the caller and one or more expected origin characteristics 641 identified from a previously captured and stored voiceprint of the actual grandson, wherein the expected origin characteristics 641 may comprise the identity of the grandson. In some embodiments, the comparative analysis performed by the audio analytics system 600 may generate one or more origin characteristic results 642 that may be presented via at least one user interface, such as, for example and not limitation, upon a display screen of a smartphone used by the elderly person during the call.

In some non-limiting exemplary implementations, the origin characteristic results 642 may comprise a determination that the bad actor is not the grandson of the person being called. In some non-limiting exemplary embodiments, the audio analytics system 600 may perform or instigate one or more remedial actions to prevent the bad actor from successfully completing the fraudulent act, such as ending the call, alerting the person being called of the determined security risk, alerting the police or other relevant authorities, and/or alerting a third-party security company or fraud prevention organization, as non-limiting examples.

As another non-limiting illustrative example, an unknown person's voice may be captured and processed or analyzed during a phone call with an insurance agency, bank, or other financial institution or business entity. In some aspects, by way of example and not limitation, at least one audio capture device 630 may be directly or indirectly integrated with the financial institution's phone system such that the audio capture device 630 may be configured to capture the caller's voice and execute one or more operations on the voice data to identify one or more potential origin characteristics 640 of the caller to determine the identity of the caller or verify the identity of the caller to confirm that the caller is the actual policy holder of the relevant policy or account, wherein such identity determination or verification may be presented to one or more employees of the financial institution via at least one user interface. In some aspects, at least one phone used by the financial institution may comprise the audio capture device 630.

In some non-limiting exemplary embodiments, by retrieving a voiceprint of the actual policy or account holder stored in at least one database or accessing such voiceprint from a data stream or file via at least one network connection, the audio analytics system 600 may execute one or more operations on the voiceprint to identify one or more expected origin characteristics 641 of the policy or account holder, and by comparing the expected origin characteristics 641 to one or more identified potential origin characteristics 640 associated with the unknown caller, the audio analytics system 600 may be able to generate one or more origin characteristic results 642 that may comprise a determination that the caller is not the rightful owner of the relevant policy or account, wherein the origin characteristic results 642 may be presented via at least one user interface.

In some non-limiting exemplary implementations, a determination of a fraudulent caller may cause the audio analytics system 600 to perform or instigate one or more remedial actions to prevent any type of fraud from occurring, such as ending the call, alerting the financial institution of the potential security risk, alerting the police or other relevant authorities, and/or alerting a third-party security company or fraud prevention organization, as non-limiting examples. In some aspects, by using a voiceprint analysis to verify the identity of a policy or account owner, the audio analytics system 600 may provide enhanced security by requiring more than general account information and knowledge of a policy or account owner's personal details to access the relevant policy or account.

In some non-limiting exemplary embodiments, the audio analytics system 600 may be trained to execute one or more operations on a received audio source 610 to identify one or more potential origin characteristics 640 of an origin of the audio source 610 that may indicate that the origin is experiencing one or more types of voice stress when emitting the audio source 610, which, by way of example and not limitation, may cause the audio analytics system 600 to determine that the origin is being deceitful or is engaging in fraudulent behavior. By way of example and not limitation, an individual may submit verbal testimony during a court proceeding, wherein the individual may make one or more false statements. While making the false statements, the individual may subconsciously strain one or more vocal cords more than usual due to feeling pressure associated with telling a lie, thereby causing the individual's voice to be slightly altered in a way that, when captured by an audio capture device 630 configured within the courtroom, may allow the audio analytics system to identify one or more potential origin characteristics 640 that comprise an indication that the individual is likely not being truthful.

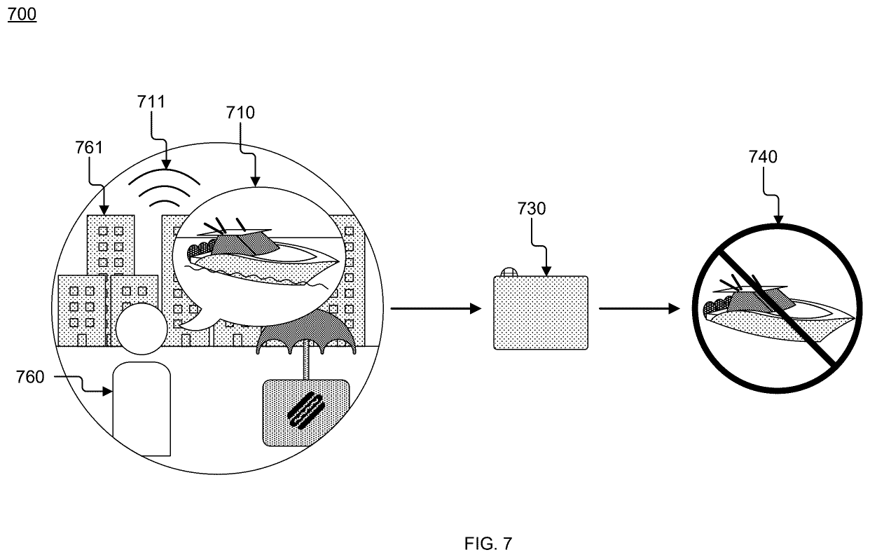

Referring now to FIG. 7, an exemplary audio analytics system 700 comprising an audio source 710, according to some aspects of the present disclosure, is illustrated. In some aspects, the audio analytics system 700 may comprise at least one primary audio source 710 and at least one secondary audio source 711. In some implementations, the audio analytics system 700 may comprise at least one audio capture device 730. In some aspects, the audio analytics system 700 may be configured to determine and present one or more origin characteristic results 740 based at least partially on a comparison between one or more potential origin characteristics associated with at least one of: the origin 760 of the primary audio source 710 or the origin 761 of the secondary audio source 711.

In some implementations, the audio analytics system 700 may be configured to execute a first at least one operation on at least one received primary audio source 710 and/or at least one received secondary audio source 711 that enables the audio analytics system 700 to identify one or more potential origin characteristics of the primary audio source 710 and/or the secondary audio source 711, wherein the secondary audio source 711 may comprise background noise or one or more environmental or location-based soundscapes. In some aspects, sound waves may be absorbed and reflected differently by different materials, producing various acoustic effects that the audio analytics system 700 may be able to identify what objects or structures may be proximate to the origin 710 of the primary audio source 710 or where the origin 760 may be located, as non-limiting examples.

As a non-limiting illustrative example, during a phone call, a caller may say that they are enjoying the day out on a boat, wherein the caller's voice may comprise a primary audio source 710. However, an audio capture device 730 associated with one or more of the phones used during the call may detect at least one secondary audio source 711 that comprises at least a portion of the background soundscape of the caller and execute one or more operations on the secondary audio source 711 to identify at least one potential origin characteristic of the origin 761 of the secondary audio source 711 that may indicate that the caller is actually located on land. By way of example and not limitation, the identified potential origin characteristics of the origin 761 may comprise an identification that the soundscape at least partially comprises a plurality of concrete buildings, a concrete wharf, or background noise that comprises car horns, tire noises on asphalt, and other traffic sounds, as non-limiting examples. In some aspects, the audio analytics system 700 may further identify one or more potential origin characteristics of the origin 760 of the primary audio source 710 that comprise an indication of the claimed location of the origin 760 such as, for example and not limitation, by recognizing one or more key words, key sounds, or key sound features such as, for example and not limitation, one or more absorbed or reflected sound waves that may indicate the compression of one or more nearby materials or structures. In some implementations, the potential origin characteristics of the origin 761 of the secondary audio source 711 may be compared by the audio analytics system 700 to the potential origin characteristics associated with the origin 760 of the primary audio source 710 to determine one or more origin characteristic results 740 that may indicate that the origin 760 of the primary audio source 710 is not at the claimed location.

As an additional non-limiting illustrative example, an employee may comprise an origin 760 of a primary audio source 710, wherein the employee may call an employer to request a day off due to feeling sick and wanting to stay home. However, an audio capture device 730 associated with the employer's phone may detect a secondary audio source 711 that comprises the background soundscape for the employee and identify one or more potential origin characteristics related to the origin 761 of the secondary audio source 711 that may comprise an identification of background noises that include seagull sounds and ocean waves, thereby allowing the audio analytics system 700 to recognize that the employee is likely to be on a boat or at the beach and not at home lying in bed.

In some implementations, the audio analytics system 700 may be configured to identify one or more potential origin characteristics that may indicate that an audio source 710 comprises a recording and not a real-time emission from an origin 760 due to recorded audio sources 71″ comprising various formatting or compression elements. This may be useful, for example and not limitation, in circumstances wherein a recorded audio source 710 may be used in an attempt to commit a deceitful or fraudulent act.

As a non-limiting illustrative example, a bad actor may call a bank account owner, and during the call the bad actor may record a plurality of words and phrases spoken by the account owner. The bad actor may then use audio equipment to splice the words and phrases in various desired ordered sequences such that the bad actor may call the relevant bank and use the recorded voice of the account owner to try to withdraw funds. If the bank's telecommunication infrastructure comprises the audio analytics system 700, then the audio analytics system 700 may identify potential audio characteristics that indicate that the voice is a recording, wherein such indication may be presented to one or more bank employees or administrators to allow them to take one or more precautionary actions to safeguard the account owner's finances.

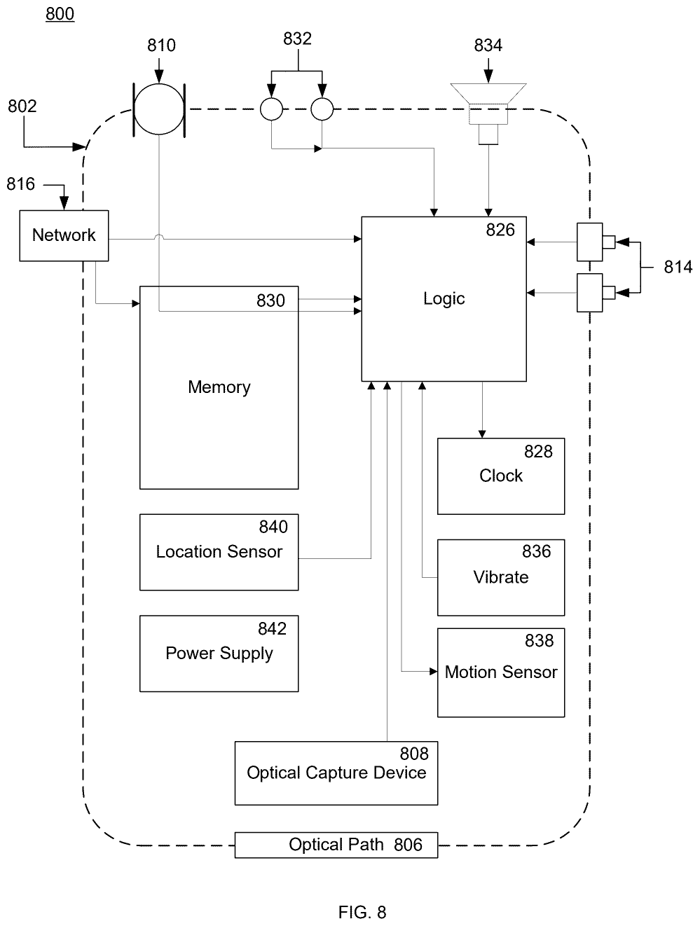

Referring now to FIG. 8, a block diagram of an exemplary computing device 802 that may at least partially comprise an audio analytics system, according to some embodiments of the present disclosure, is illustrated. The computing device 802 may comprise an optical capture device 808, which may capture an image and convert it to machine-compatible data, and an optical path 806, typically a lens, an aperture, or an image conduit to convey the image from the rendered document to the optical capture device 808. The optical capture device 808 may incorporate a Charge-Coupled Device (CCD), a Complementary Metal Oxide Semiconductor (CMOS) imaging device, or an optical sensor of another type.

In some embodiments, the computing device 802 may comprise a microphone 810, wherein the microphone 810 and associated circuitry may convert the sound of the environment, including spoken words, into machine-compatible signals. Input facilities 814 may exist in the form of buttons, scroll-wheels, or other tactile sensors such as touch-pads. In some embodiments, input facilities 814 may include a touchscreen display. Visual feedback 832 to the origin may occur through a visual display, touchscreen display, or indicator lights. Audible feedback 834 may be transmitted through a loudspeaker or other audio transducer. Tactile feedback may be provided through a vibration module 836.

In some aspects, the computing device 802 may comprise a motion sensor 838, wherein the motion sensor 838 and associated circuitry may convert the motion of the computing device 802 into machine-compatible signals. For example, the motion sensor 838 may comprise an accelerometer, which may be used to sense measurable physical acceleration, orientation, vibration, and other movements. In some embodiments, the motion sensor 838 may comprise a gyroscope or other device to sense different motions.

In some implementations, the computing device 802 may comprise a location sensor 840, wherein the location sensor 840 and associated circuitry may be used to determine the location of the device. The location sensor 840 may detect Global Position System (GPS) radio signals from satellites or may also use assisted GPS where the computing device 802 may use a cellular network to decrease the time necessary to determine location. In some embodiments, the location sensor 840 may use radio waves to determine the distance from known radio sources such as cellular towers to determine the location of the computing device 802. In some embodiments these radio signals may be used in addition to and/or in conjunction with GPS.

In some aspects, the computing device 802 may comprise a logic module 826, which may place the components of the computing device 802 into electrical and logical communication. The electrical and logical communication may allow the components to interact. Accordingly, in some embodiments, the received signals from the components may be processed into different formats and/or interpretations to allow for the logical communication. The logic module 826 may be operable to read and write data and program instructions stored in associated storage 830, such as RAM, ROM, flash, or other suitable memory. In some aspects, the logic module 826 may read a time signal from the clock unit 828. In some embodiments, the computing device 802 may comprise an on-board power supply 842. In some embodiments, the computing device 802 may be powered from a tethered connection to another device, such as a Universal Serial Bus (USB) connection.

In some implementations, the computing device 802 may comprise a network interface 816, which may allow the computing device 802 to communicate and/or receive data to a network and/or an associated computing device. The network interface 816 may provide two-way data communication. For example, the network interface 816 may operate according to an internet protocol. As another example, the network interface 816 may comprise a local area network (LAN) card, which may allow a data communication connection to a compatible LAN. As another example, the network interface 816 may comprise a cellular antenna and associated circuitry, which may allow the computing device 802 to communicate over standard wireless data communication networks. In some implementations, the network interface 816 may comprise a Universal Serial Bus (USB) to supply power or transmit data. In some embodiments, other wireless links known to those skilled in the art may also be implemented.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). There may be various components of the present invention that are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

1. A method for an audio analytics system, comprising:
receiving at least one audio source by an audio capture device, wherein the audio capture device includes at least one portable computing device, wherein the at least one audio source is emitted from at least one human or animal origin;
executing a first at least one operation by at least one artificial intelligence infrastructure of the at least one audio capture device on the at least one audio source, wherein execution of the at least one operation references at least one parameter, wherein the at least one parameter is stored in at least one storage medium of the audio analytic system;
identifying at least one first set of origin characteristic of the at least one audio source based on the execution of the first at least one operation, wherein the at least one first set of origin characteristics comprises an embedding;
executing a second at least one operation by at least one artificial infrastructure of the at least one audio capture device on the at least one audio source on the smaller dimensionality of the embedding; and
identifying at least one second set of origin characteristics of the at least one audio source based on the execution of the at least one second operation, wherein the at least one second set of origin characteristics comprises an indication of a physical condition of the at least one human or animal origin.

2. The method of claim 1, wherein the audio analytics system further indicates whether the at least one or more audio source includes an emotional condition.

3. The method of claim 1, wherein the audio analytics system indicates whether the at least one or more audio source includes a medical condition.

4. The method of claim 1, wherein the method further includes:
training at least one artificial intelligence infrastructure to execute at least one operation on a received at least one audio source to identify one or more potential origin characteristics of the at least one audio source.

5. The method of claim 4, wherein the at least one potential origin characteristic includes health of an origin of the audio source, wherein the audio source comprises a human or animal.

6. The method of claim 5, wherein the audio analytics system distinguishes between animal sounds and human sounds.

7. The method of claim 5, wherein the at least one potential origin characteristic identifies neurological impairment.

8. The method of claim 5, wherein the at least one potential origin characteristic identifies muscular impairment.

9. The method of claim 1, wherein the audio analytics system is trained to identify one or more potential origin characteristics of an origin of an audio source that indicates whether the origin is under influence of substances.

10. The method of claim 1, wherein the method further includes indicating that the origin is experiencing one or more types of voice stress when emitting the audio source.

11. The method of claim 8, wherein audio analytics system determines whether the origin is engaging in fraudulent behavior.

12. The method of claim 1, wherein a determination of accuracy of the one or more potential origin characteristics identified for each training source received by the audio analytics system at least partially comprises execution of an at least one loss function.

13. The method of claim 12, wherein the loss function is configured to determine classification loss and regression loss for each identified potential origin characteristics such that the audio analytics system is trained to accurately predict at least one class/distribution range for one or more of the potential origin characteristics.

14. The method of claim 13, wherein the loss function at least partially includes at least one linear quadratic estimation algorithm.

15. The method of claim 1, wherein the audio analytics system includes one or more databases, servers, or other storage media that collectively serve as a library of previously captured, previously recorded, or currently streamed training sources.

16. The method of claim 1, wherein the at least one audio source is an animal, wherein the audio analytics system identifies one or more potential origin characteristics of at least one animal sound.

17. The method of claim 1, wherein the audio analytics system includes one or more databases, servers, or other storage media that collectively serve as a library of previously captured, previously recorded, or currently streamed training sources.

18. The method of claim 1, wherein at least a portion of the training data derived from the training sources received by the audio analytics system is at least partially augmented, wherein augmenting training data partially comprises a replicating and applying one or more audio quality influencers to the training sources.

19. The method of claim 1, wherein the audio analytics system receives training sources via one or more existing communication infrastructures.

20. The method of claim 19, wherein one of more components or groups of components within the one or more existing communication infrastructures is used by the audio analytics system as an audio capture device.
